(19) United States
(12) Patent Application Publication
(10) Pub. No.: US 2007/0100950 A1
(43) Pub. Date: May 3, 2007

(54) Method for automatic retention of critical corporate data

(76) Inventors: William Bornstein, Hopewell Junction, NY (US); Anthony Cappa Spielberg, Austin, TX (US)

Correspondence Address: DUKE W. YEE;YEE & ASSOCIATES, P.C., P.O. BOX 802333, DALLAS, TX, 75380, US

(21) Appl. No.: 11/266,661

(22) Filed: Nov. 3, 2005

(51) Int. Cl. G06F 15/16

(52) U.S. Cl. 709/206

(57) ABSTRACT

An electronic mail retention mechanism for automatically retaining critical corporate e-mail data. The e-mail retention mechanism analyzes each e-mail in the corporate e-mail system based on a set of relevancy criteria for a particular area of interest. Relevancy criteria in the form of interrelated arguments and algorithms are used to identify relevant or critical e-mail data. When an e-mail has been identified as relevant to the area of interest, the e-mail retention mechanism may flag the e-mail as comprising relevant data, for example, by storing a copy of the e-mail in a specific location in memory, using information in the message to create a unique identifier for that message, or inserting a relevancy marker into the e-mail. The relevant e-mail may then be copied to and stored in an archive database to allow for long-term storage of this critical data.

### BACKGROUND OF THE INVENTION

1. Field of the Invention:

The present invention relates generally to an improved data processing system for electronic mail retention. In particular, the present invention provides an electronic mail system for automatically retaining critical corporate electronic mail data.

2. Description of the Related Art:

Electronic mail (e-mail) allows a person to quickly and easily send textual messages and other information, such as, for example, pictures, sound recordings, and formatted documents electronically to other e-mail users anywhere in the world. An e-mail system typically involves a server-based mail program residing on a server computer to manage the exchange of e-mail messages over one or more networks and store user messages, and a client-based mail program residing on the client to implement a mail box that allows access to those e-mail messages stored on the server. Typically, these client-based programs also include a graphical user interface to enable a user to easily and conveniently open and read e-mail messages in addition to creating new e-mail messages.

One problem that exists in current corporate e-mail systems is that as businesses can generate vast amounts of e-mail, it is often impractical or impossible to archive all of the e-mail. Businesses may address this limitation by placing automatic time limits on how long an e-mail can be stored on the e-mail server, as well as placing automatic time limits on the client machine. When the time limit for an e-mail has expired, the e-mail is automatically deleted from the system.

Although current systems have allowed for managing stored e-mails based on time limits, this process can create other problems for businesses. For instance, circumstances may arise that require all e-mails concerning a given subject be retained. One example is when litigation or governmental investigation requires the business to maintain all records pertaining to a given subject. In such circumstances, a business can face serious legal trouble if relevant e-mails are deleted, regardless of whether the deletion was intentional (i.e., automatic deletion) or otherwise. Consider, for example, a company that has a standing rule by which e-mail older than sixty days will be automatically deleted, and the company is ordered to retain documents concerning a given subject. If the company does not change its rule, the company may be fined large sums of money if messages concerning a given subject are lost because of the automatic deletion policy.

Current solutions to this problem involve instructing those individuals who might possess relevant e-mail to take appropriate action to save relevant e-mails, such as overriding the automatic deletion rules for their e-mail systems. These solutions are problematic, however, since such solutions rely on chains of human communication and human responses to the communications. Consequently, these existing solutions will always be error-prone, incomplete, and unreliable.

Therefore, it would be advantageous to have a mechanism for automatically retaining critical corporate e-mail data.

### SUMMARY OF THE INVENTION

The present invention provides an e-mail retention mechanism for automatically retaining critical corporate e-mail data. The e-mail retention mechanism analyzes each e-mail in the corporate e-mail system based on a set of relevancy criteria for a particular area of interest. Relevancy criteria in the form of interrelated arguments and algorithms are used to identify relevant or critical e-mail data. When an e-mail has been identified as relevant to the area of interest, the e-mail retention mechanism may flag the e-mail as comprising relevant data, for example, by storing a copy of the e-mail in a specific location in memory, using information in the message to create a unique identifier for that message, or inserting a relevancy marker into the e-mail. The relevant e-mail may then be copied to and stored in an archive database to allow for long-term storage of this critical data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system that may be implemented in accordance with an illustrative embodiment of the present invention;

FIG. 3 is a block diagram of an exemplary electronic mail messaging system in accordance with an illustrative embodiment of the present invention;

FIG. 4 is an example graphical user interface for invoking an e-mail retention module in accordance with an illustrative embodiment of the present invention;

FIG. 5 is a flowchart of a process for automatic retention of critical corporate data in accordance with an illustrative embodiment of the present invention; and

FIG. 6 is a flowchart of a process for updating the relevancy criteria used to preserve critical corporate data in accordance with an illustrative embodiment of the present invention.

### DETAILED DESCRIPTION OF THE PREFERRED EMBODIMENT

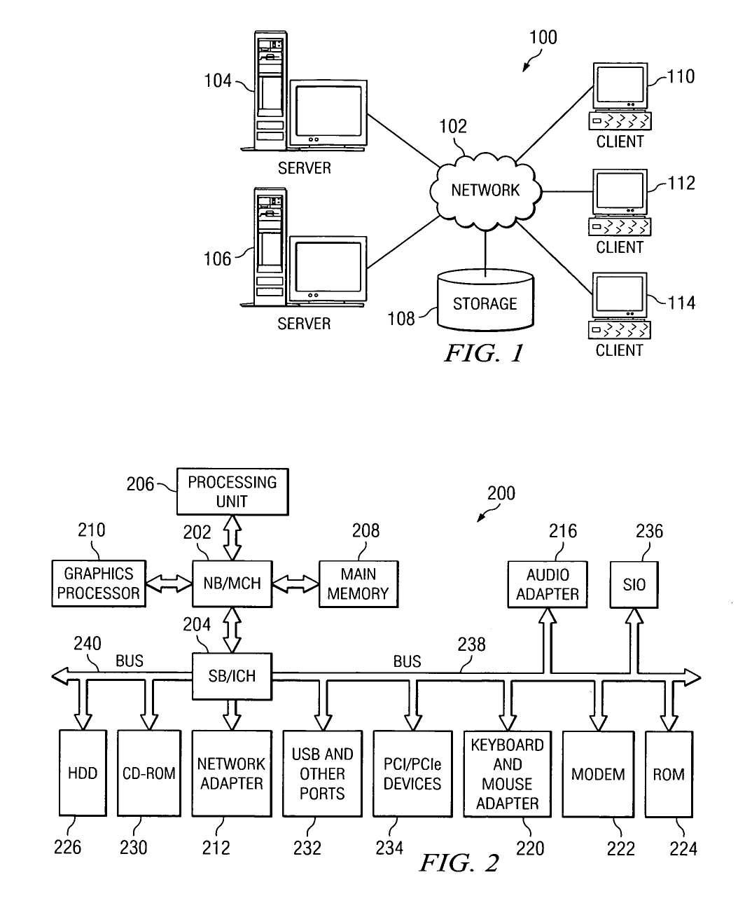

FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsof® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The present invention provides an electronic mail system for retaining critical corporate data. When circumstances arise that require all e-mails concerning a given area of interest be retained beyond the company's existing e-mail storage policies, the mechanism of the present invention may be used to ensure the retention of such critical data without having to rely on individuals possessing relevant e-mail data to take appropriate action to save the data. As businesses generate large volumes of messaging data, the present invention allows for filtering relevant e-mails pertaining to the particular area of interest from general or irrelevant e-mails, and storing only those e-mails meeting a given relevancy criteria without having to rely on human intervention to adhere to imposed retention requirements.

As e-mail messages are generated by users and routed through the network, the e-mail retention mechanism analyzes each message based on a set of relevancy criteria for the particular area of interest. When the e-mail retention module has identified an e-mail as relevant to the area of interest, the e-mail retention module may flag the e-mail as comprising relevant data. This flag may take the form of storing a copy of the e-mail mail in a specific location in memory. The e-mail retention module may also flag an e-mail as a relevant message by generating a unique identifier for the message, such that flagged messages may be later located by their unique identifiers. The e-mail retention module may also insert a marker into the header or footer of the e-mail, or any other portion of the e-mail as well, to indicate that the e-mail message comprises relevant data. By flagging the e-mail as “relevant”, the e-mail retention system may subsequently handle that e-mail as a critical e-mail. The relevant e-mail may then be copied to and stored in an archive database to allow for long-term storage of this critical data.

Relevancy criteria in the form of arguments and algorithms are used by the e-mail retention module to identify critical e-mail data. The e-mail retention module of the present invention allows for creating many possible ways to be alerted to relevant e-mail data by interrelating search arguments and algorithms, which together allow the retention system to make intelligent decisions on which e-mail messages to retain and archive. Examples of such arguments and algorithms used for linking subjects and e-mail messages may include, but are not limited to, rules that link organizational charts comprising names and titles of individuals and departments to projects being executed by those individuals/organizations, rules that link individuals' names to job responsibilities and project responsibilities, rules that link specific words to specific subjects, rules that track locality of reference for individual e-mail messages (in time and in matching against other arguments), and algorithms that score individual pieces of e-mail against existing arguments.

Various arguments and algorithms may be used alone or in combination to allow the e-mail retention module to make an intelligent decision regarding whether a particular e-mail contains critical data and thus should be archived. One such set of rules may link organizational charts in a company to projects being executed by those organizations, wherein the organizational charts contain names and titles of individuals and departments in the company. For example, the department in which an employee works may provide information about the relevancy of the e-mail. If circumstances arise that necessitate that the company save documents related to Project “X”,any e-mail generated from, received by, or that mention employees in departments that are associated with that project should be retained, even if the e-mail turns out to not be relevant, since it is preferable to err on the side of over-inclusion. Likewise, rules may be employed that link an employee's name to job responsibilities or project responsibilities, or an employee's position in the company may provide relevancy information on what projects the employee is working. For example, if Project “X” is an accounting/financial operation, all e-mails generated from, received by, or that mention accountants that work in the company should be retained. Similarly, e-mails associated with the chief financial officer of the company should be retained with regard to Project “X”.

The relevancy of an e-mail may also be weighted, such that some identified e-mails are deemed potentially more relevant than others. For instance, as messages to or from higher-level employees may be more likely to contain corporate critical data, e-mails generated from, received by, or that mention those employees in management or executive positions will be weighted higher (i.e., more relevant) than those e-mails from lower-level employees.

Rules may also be employed that use keywords or phrases to identify messages that are specific to the areas of interest. These rules use words that are linked to specific subjects. For instance, if Company A's area of interest is its acquisition of Company B which manufactures Product “Z”,any messages containing keywords such as “Company B” or “Product Z” should be retained. Use of keywords may also be enhanced by having employees familiar with the area of interest supply keywords that may not be known by those setting up the keyword rules. For example, employees in Company A who are familiar with the acquisition of Product “Z” may provide more productive keywords reflecting specific information regarding the purchase and the product to allow for better identification of relevant e-mails.

Rules that track locality of reference may be used to indicate that e-mail messages are related in some manner, be it related in time or to users, as well as matching against other arguments. For example, if an e-mail is forwarded around to, copied by, or referred to by many employees, any e-mail that is created from or associated with one of these forwarded, copied, or referred to e-mails will be viewed as related. Thus, if one of these e-mails in this related group contains relevancy criteria, all of these related e-mails will be retained.

The e-mail retention module uses the relevancy criteria to scan the e-mails for relevant content by analyzing all aspects of the message, including the message content, the address (sender, recipients), and any links to other documents, such as e-mail attachments or Web pages. These documents are opened and scanned based on the relevancy criteria. Also, if a linked Web page is known to be relevant, any other information that is linked to the relevant Web page may be scanned and retained as well.

The relevancy criteria may be set from the top of the company down, such as company management instructing a system administrator to set up particular retention rules. Alternatively, relevancy criteria may be set based on inputs from e-mail users. An example of such input is instructing employees who worked on Project “X” to fill out a questionnaire form, and using the information from the form to develop rules for the specific retention scenario.

The relevancy criteria in the e-mail retention module may be kept up-to-date by a variety of means, including receiving automated feeds from other business systems, such as organizational charts, press releases, databases of progress reports, as well as manual adjustment by management direction or individual user input. In one example, organizational information may be obtained from an authority list such as a corporate telephone directory which has inherent content regarding a business' organizational structure, such as employee names and associated positions/titles and departments, as well as manager/subordinate hierarchical relationships. In another embodiment, the e-mail retention module may poll for updates to these information sources in the business system in order to maintain a current set of organizational information.

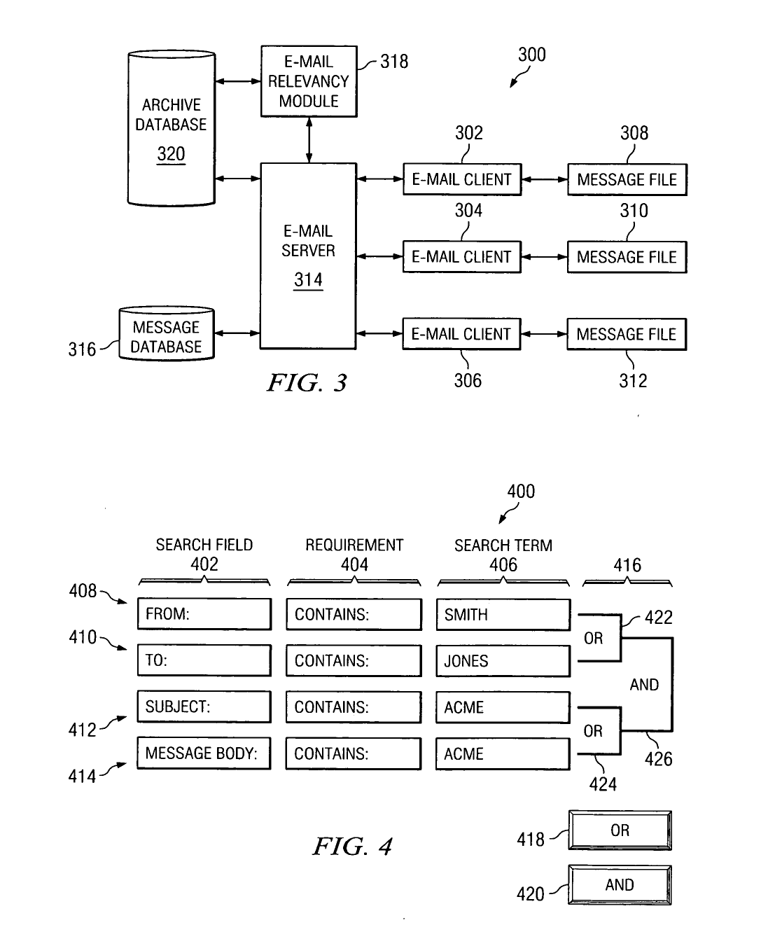

Turning now to FIG. 3, a diagram illustrating an exemplary electronic mail messaging system 300 is depicted in accordance with a preferred embodiment of the present invention. In this example, e-mail client 302, e-mail client 304, and e-mail client 306 are e-mail clients, programs, or applications located at different client data processing systems, such as client 110 client 112, and client 114 in FIG. 1. Message file 308, message file 310, and message file 312 are associated with these e-mail clients. These message files serve to store e-mail messages received by the clients and may be organized into various mailboxes. Examples of various mailboxes include, for example, an in folder, a sent folder, a deleted folder, and an outbox folder.

These e-mail programs may employ different protocols depending upon the implementation. For example, simple mail transfer protocol (SMTP) is a standard e-mail protocol that is based on TCP/IP. This protocol defines a message format and the message transfer agent, which stores and forwards the mail. Other protocols, such as post office protocol 3 (POP3), also may be employed.

These e-mail programs are used to send e-mail back and forth to different users through e-mail server 314. Messages sent to other e-mail clients may be temporarily stored in e-mail message database 316. When an e-mail client connects to e-mail server 314, any messages for that particular client are then sent to the client.

E-mail server 314 is associated with e-mail retention module 318. E-mail retention module 318 comprises the set of relevancy criteria for identifying critical e-mail data. As shown, when an e-mail message is received at e-mail server 314, e-mail retention module 318 scans the e-mail to determine whether the e-mail contains critical data using the relevancy criteria. Depending upon the settings in the e-mail system, it may be desirable to scan and archive e-mails in real-time (i.e., as they are received at the e-mail server), since a user may delete relevant e-mails from the user's message file and thus the relevant e-mail may be lost and can no longer be archived. Some e-mail systems can be set up to maintain messages on the e-mail server for a temporary period (e.g., ten days), even though the copy of the message in the client message file has been deleted. For these e-mail systems, the e-mail retention module may be scan the messages maintained in message database 316 at periodic intervals, wherein the intervals are scheduled such that all messages are inspected prior to the removal of the messages from the e-mail server 314 or from e-mail message database 316.

E-mail retention module 318 may be implemented in variety of ways, such as integrated as a software module within the existing e-mail program or as a stand-alone application program within e-mail server 314. In a first implementation where the e-mail retention module is integrated with the existing e-mail program, the e-mail retention module is used to intercept each e-mail and determine if the e-mail meets the given relevancy criteria and should be archived. If the message should be saved, the e-mail retention module may utilize the existing capabilities of the e-mail program and instruct the e-mail program to archive the e-mail message either immediately or at a specified time. In a second implementation, the e-mail retention module itself archives the relevancy e-mail data independently of the existing e-mail program. Thus, the e-mail retention module intercepts each message, scans the message, and writes the message out to an archive file in archive database 320 if the message meets the given relevancy criteria.

A relevant e-mail may be copied to and stored in archive database 320 to allow for long-term storage of the critical data. In the simplest example, relevant e- mail messages may be copied to archive database 320 and stored in a single “flat” file, with no indexing information available to the user. In another example, copies of the relevant e-mail messages may also be stored in a flat-file database. Each e-mail message is part of a single database record, and each database record comprises the e-mail message plus additional fields by which the message can be sorted, matched, or otherwise manipulated. For instance, these additional fields may include yes/no checkboxes for indicating whether the message matched a specific rule or keyword in the relevancy criteria. Another example of archiving relevant e-mail messages comprises storing each copied e-mail message in a fully relational database. Each copied e-mail message is stored as a database record, where each database record comprises the e-mail message and an index field (often called a “key field”) by which that message can be uniquely identified within the relational database. Other tables within the relational database may be used to link the specific e-mail message to other message attributes, such as connecting the e-mail message to relevancy rules applied, etc.

E-mail retention module 318 may also apply relevancy weighting to the relevant e-mails. E-mail messages having a higher weight will be deemed as potentially more relevant to the area of interest than the other archived e-mails. The e-mail retention system may also include with each archived message more specific information about why the message was chosen for preservation. This specific information may include, for example, the relevancy rules and criteria that were in effect at the time that caused the retention of the e-mail message, as well as how the e-mail message scored with regard to those rules and criteria. Depending upon the structure of the archive database structured, i.e., as a flat-file database, a relational database, or other, the user may view the relevancy weighting and query arguments among a set of results, e.g., color coding, numerical goodness-of-matching values, etc.

FIG. 4 is an example graphical user interface for invoking an e-mail retention module in accordance with an illustrative embodiment of the present invention. Graphical user interface 400 provides a means through which a user may invoke the retention process and specify the arguments and rules used in determining e-mail message relevancy. Graphical user interface 400 may be presented to user in a data processing system, such as e-mail clients 302-306 in FIG. 3. Although the example in FIG. 4 shows a particular graphical user interface configuration, it should be noted that any user interface that allows for setting and modifying e-mail message relevancy may be used without departing from the spirit and scope of the present invention.

In this illustrative example, graphical user interface 400 includes an array of columns and rows. Each column in graphical user interface 400 comprises one of a search field 402, requirement field 404, or search term field 406. Each row in graphical user interface 400, such as rows 408-414, forms an individual simple condition, wherein the condition consists of a single search field combined with a single requirement combined with a single search term.

Contents within search field 402 indicate the portion of each e-mail message which is to be analyzed by the e-mail retention system of the present invention. Examples of choices for search field XXX include all of the typical fields found in an e-mail message header, such as “From:”, “To:”, “Subject:”, “CC:”, “BCC:”, “Date Sent:”, and the like.

Contents within requirement field 404 indicate how the contents of the search field are to be analyzed with respect to the search term for the row. For instance, when analyzing portions of an e-mail message that contain text, typical choices for requirement field 404 may include “contains”, “does not contain”, “starts with”, and “ends with”. When analyzing portions of an e-mail message that contain dates, typical choices for requirement field 404 may include “on”, “before”, “after”, “on or before”, and “on or after.” When analyzing portions of an e-mail message that contain numbers, typical choices for requirement field 404 may include “equals”, “does not equal”, “less than”, “greater than”, “less than or equal to”, and “greater than or equal to”.

Contents within search term field 406 indicate the value of interest for which search field 402 for the row is to be searched.

Graphical user interface 400 may allow the user to enter information in each of the input boxes for search field 402, requirement field 404, and search term field 406 using several methods, including pull-down lists, pop-up menus of choices, automatic searching of choices based on characters entered into the input boxes, or unrestricted entry of text by the user using the computer keyboard or other method of text entry (e.g., voice recognition and transcription.)

Graphical user interface 400 also contains graphical indication 416 of how the individual simple conditions specified in each row are combined to form a more complicated condition which is used to make a determination of an e-mail message relevancy. Graphical user interface 400 provides the user with graphical methods by which some or all of the individual simple conditions may be selected, then combined using standard logical operators. Such methods could include having the user first define several individual conditions, then allow the user to click on a logical operator button, such as “OR” button 418, which would then have the effect of creating on the computer display an indication that the selected conditions had been combined using a logical “OR” operation, as illustrated by the bracket connecting row 1 408 and row 2 410. 53In this particular example, four simple conditions are specified: the condition in row 1 408 specifies that the “From” field of the e-mail message will be searched to determine if the “From” field contains the character string “Smith”; the condition in row 2 410 specifies that the “From” will be searched to determine if it contains the character string “Jones”; the condition in row 3 412 specifies that the “Subject” field will be searched to determine if it contains the character string “Acme”; and the condition in row 4 414 specifies that the “Message Body” contains the character string “Acme.”

Graphical indication 416 shows brackets labeled “OR” and “AND” to represent a graphical method of choosing how the individual simple conditions (rows 1-4) are to be combined into a single complex condition by which e-mail message relevancy is to be evaluated. A user may select the logical operators to combine multiple conditions using clickable “OR” button 418 and “AND” button 420.

In addition to combining individual simple conditions, the user may also apply the procedure of combining conditions by clicking on a logical operator button to create a logical combination to the logical combinations of individual simple conditions themselves. For example, graphical indicator 416 shows that the user has combined the conditions in row 1 408 and row 2 410 together using the logical operator “OR”, and that the user has combined the conditions in row 3 412 and row 4 414 together also by using the logical operator “OR”. Selecting “OR” brackets 422 and 424 and then clicking on “AND” button 420 has the effect of combining all of the conditions and creating on the computer display. an indication that the selected “OR” combinations had been combined using a logical “AND” operation to form “AND” combination 426.

It should be noted that FIG. 4 illustrates a graphical user interface by which rules and arguments may be specified which relate to the content of e-mail messages considered individually. Similar techniques may be used to provide a graphical method of allowing a user to specify rules and arguments which relate e-mail messages to other sources of information (such as organization charts, progress reports, internal memos, and other documentation) or to other e-mail messages.

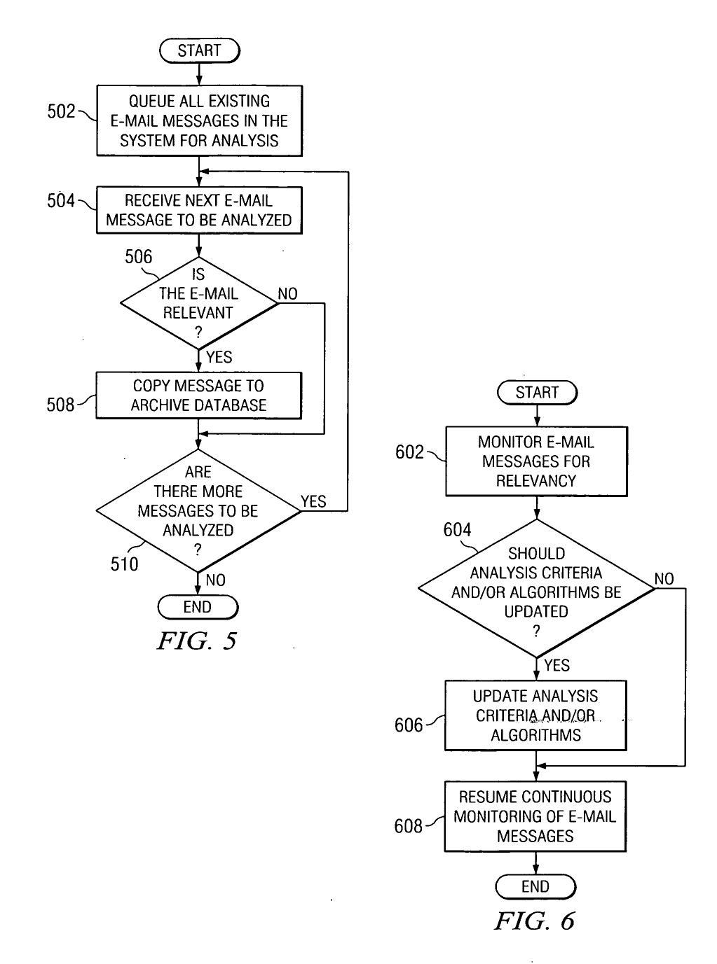

Turning next to FIG. 5, a flowchart of a process for automatic retention of critical corporate data is depicted in accordance with illustrative embodiments of the present invention. The process illustrated in FIG. 5 may be implemented in an e-mail messaging system, such as e-mail system 300 in FIG. 3. When a particular situation arises that requires long-term retention of relevant e-mail, relevant corporate data may be identified and retained for a period of time longer than the corporation's existing procedures for retaining general e-mail, and without having to rely on employee action to do so.

The process begins with queuing all existing e-mail messages in the e-mail system for analysis (step 502). The existing e-mail messages may comprise those e-mail messages currently present on the e-mail server, such as within message database 316 in FIG. 3. Once the e-mail messages in the system are queued, the e-mail retention receives the next e-mail message in the queue and begins to analyze the e-mail message (step 504). In analyzing a particular e-mail, a determination is made as to whether the e-mail in question is a relevant e-mail (step 506). The e-mail retention system may determine if the message is relevant by using relevancy criteria specific to the area of interest. The relevancy criteria may employ arguments and algorithms to filter on the contents of the subject line of the message, body of the message, or attachments or links accompanying the message. Thus, if the body of an e-mail comprised content that meets the relevancy criteria, the e-mail retention module may distinguish the relevant e-mail from general e-mails.

If it is determined that the e-mail message is not a relevant e-mail, the process skips to step 510, where a determination is made as to whether there are more e-mail messages in the queue to be analyzed. If there are more e-mail messages in the queue to be analyzed, the process returns to step 504 and analyzes the next incoming e-mail for relevant data. If there are no more messages to be analyzed, the process terminates thereafter.

Turning back to step 506, if the e-mail meets the relevancy criteria and thus is determined to be a relevant e-mail, the e-mail retention system handles the e-mail as a relevant e-mail by copying the e-mail message to an archive database (step 508). Copying the relevancy e-mail to an archive database allows for long-term storage of this critical data. The e-mail retention system may also, prior to storing the copy of the e-mail message in an archive database, store a copy of the e-mail in a specific location in memory, use information in the message to create a unique identifier for that message, or insert a flag into the header or footer of the e-mail or any other portion of the e-mail as well. The e-mail retention system may also assign relevancy weights to each relevant e-mail and store information with each archived message indicating why the message was chosen for preservation (e.g., include the relevancy criteria rules that were in effect at the time which caused the message to be retained). A determination is then made as to whether there are more e-mail messages in the queue to be analyzed (step 510). If there are more e-mail messages in the queue to be analyzed, the process returns to step 504 and analyzes the next incoming e-mail for relevant data. If there are no more messages to be analyzed, the process terminates thereafter.

The mechanism used to write the relevant e-mail to the database may be performed by either the e-mail retention module itself, or the e-mail retention module may utilize the capabilities of the existing e-mail system and instruct the e-mail system to write the relevant e-mail to the archived database. The archive database may be a separate and distinct storage repository from the general e-mail system. In one embodiment, the archive database is set up with automatic redundant backup techniques, and thus the archived database itself may be protected. The archived database may be backed up using methods of data backup and records retention commonly practiced in the data-processing industry. In this manner, the archived e-mails may be permanently saved and protected from loss or corruption.

FIG. 6 is a flowchart of a process for updating the relevancy criteria used to preserve critical corporate data in accordance with an illustrative embodiment of the present invention. The process illustrated in FIG. 6 may be implemented in an e-mail messaging system, such as e-mail system 300 in FIG. 3.

The process begins with the e-mail retention system monitoring the e-mail messages in the queue for relevancy (step 602). A determination is then made as to whether there is a need to update the relevancy analysis criteria and/or algorithms for the area of interest (step 604). The e-mail retention system may base this determination upon whether there have been updates to the relevancy criteria used to analyze the e-mail messages. These updates may include, but are not limited to, receiving or detecting a manual input from an individual e-mail user, a manual input from a system administrator, or an automatic input from another business system in the enterprise, or any combination of the above. If the e-mail retention system determines that no updates to the analysis criteria and/or algorithms are needed, the e-mail mail retention system resumes the continuous monitoring of the e-mail messages for relevancy (step 608).

Turning back to step 604, if a determination is made that updates are needed, the e-mail retention system updates the analysis criteria and/or algorithms based on the received or detected manual and/or automatic inputs of the individual e-mail user, the system administrator, or another business system in the enterprise (step 606). The e-mail retention system then resumes the continuous monitoring of the e-mail messages for relevancy, wherein the relevancy criteria updates are used in monitoring the e-mail messages (step 608).

Thus, the present invention provides an e-mail retention module for automatically retaining critical corporate e-mail data. The advantages of the present invention should be apparent in view of the detailed description provided above. Although a company may currently instruct its employees to take appropriate action to save e-mail messages that pertain to specific areas of interest, problems may still arise since the company must rely on adequate human response to the directive. Rather than relying on human communication and human response (which can be error-prone, incomplete, and unreliable), the present invention not only automatically retains e-mails identified as relevant to the area of interest, but the present invention also provides a mechanism for generating, based on arguments and algorithms, intelligent decisions regarding which e-mails should be retained.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. 67Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system is suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for automatically retaining electronic mail messages, the computer-implemented method comprising:
receiving an electronic mail message;
analyzing the electronic mail message to determine if the electronic mail message is a relevant electronic mail message, wherein the determination is based on relevancy criteria specific to an area of interest, and wherein the relevancy criteria comprises a set of interrelated arguments and algorithms;
responsive to a determination that the electronic mail message satisfies the relevancy criteria, creating a copy of the electronic mail message; and
storing the copy of the electronic mail message.

2. The computer implemented method of claim 1, wherein the copy of the electronic mail message is stored in an archive database, wherein the archive database is a storage repository separate from the electronic mail system.

3. The computer implemented method of claim 1, further comprising:
responsive to a determination that the electronic mail message satisfies the relevancy criteria, flagging the electronic mail message, wherein the flagging step comprises generating a identifier code by which the electronic mail message is uniquely identifiable within an electronic mail system.

4. The computer implemented method of claim 1, further comprising:
responsive to a determination that the electronic mail message satisfies the relevancy criteria, flagging the electronic mail message, wherein the flagging step comprises inserting a relevancy indicator into at least one of the header, footer, address, or body of the electronic mail message.

5. The computer implemented method of claim 1, wherein the analyzing step filters relevant electronic mail messages by applying the relevancy criteria to at least one of address information of the electronic mail message, content of the electronic mail message, or attachments or links accompanying the electronic mail message.

6. The computer implemented method of claim 1, wherein the analyzing step is performed on at least one of electronic mail messages residing on an electronic mail server or electronic mail messages received from an electronic mail client.

7. The computer implemented method of claim 1, wherein the set of interrelated arguments and algorithms include at least one of rules linking organizational charts to projects, rules linking individuals to work responsibilities, rules linking keywords to subjects, rules tracking locality of reference for individual electronic mail messages in time or users, or algorithms scoring electronic mail messages against existing arguments.

8. The computer implemented method of claim 2, wherein the archive database comprises automatic redundant backup techniques.

9. The computer implemented method of claim 1, further comprising:
assigning a relevancy weight to the electronic mail message.

10. The computer implemented method of claim 9, wherein electronic mail messages generated from, received by, or that mention higher level employees are assigned higher relevancy weights, and electronic mail messages generated from, received by, or that mention lower level employees are assigned lower relevancy weights.

11. The computer implemented method of claim 1, wherein the relevancy criteria is updated by at least one of receiving automated feeds from updated organizational charts, press releases, databases of progress reports, or manual adjustment by management direction.

12. A data processing system for automatically retaining electronic mail messages, comprising:
a bus;
a storage device connected to the bus, wherein the storage device contains computer usable code;
at least one managed device connected to the bus;
a communications unit connected to the bus; and a processing unit connected to the bus, wherein the processing unit executes the computer usable code to receive an electronic mail message, analyze the electronic mail message to determine if the electronic mail message is a relevant electronic mail message, wherein the determination is based on relevancy criteria specific to an area of interest, and wherein the relevancy criteria comprises a set of interrelated arguments and algorithms, create a copy of the electronic mail message in response to a determination that the electronic mail message satisfies the relevancy criteria, and store the copy of the electronic mail message.

13. The data processing system of claim 12, wherein the copy of the electronic mail message is stored in an archive database, wherein the archive database is a storage repository separate from the electronic mail system.

14. The data processing system of claim 12, wherein the processing unit further executes computer usable code to flag the electronic mail message in response to a determination that the electronic mail message satisfies the relevancy criteria, wherein the flagging step comprises at least one of generating a identifier code by which the electronic mail message is uniquely identifiable within an electronic mail system, or inserting a relevancy indicator into at least one of the header, footer, address, or body of the electronic mail message.

15. The data processing system of claim 12, wherein the analyzing step filters relevant electronic mail messages by applying the relevancy criteria to at least one of address information of the electronic mail message, content of the electronic mail message, or attachments or links accompanying the electronic mail message.

16. The data processing system of claim 12, wherein the set of interrelated arguments and algorithms include at least one of rules linking organizational charts to projects, rules linking individuals to work responsibilities, rules linking keywords to subjects, rules tracking locality of reference for individual electronic mail messages in time or users, or algorithms scoring electronic mail messages against existing arguments.

17. The data processing system of claim 12, wherein the processing unit further executes computer usable code to assign a relevancy weight to the electronic mail message, wherein electronic mail messages generated from, received by, or that mention higher level employees are assigned higher relevancy weights, and electronic mail messages generated from, received by, or that mention lower level employees are assigned lower relevancy weights.

18. A computer program product for automatically retaining electronic mail messages, the computer program product comprising:
a computer usable medium having computer usable program code tangibly embodied thereon, the computer usable program code comprising:
computer usable program code for receiving an electronic mail message;
computer usable program code for analyzing the electronic mail message to determine if the electronic mail message is a relevant electronic mail message, wherein the determination is based on relevancy criteria specific to an area of interest, and wherein the relevancy criteria comprises a set of interrelated arguments and algorithms;
computer usable program code for creating a copy of the electronic mail message in response to a determination that the electronic mail message satisfies the relevancy criteria; and
computer usable program code for storing the copy of the electronic mail message.

19. The computer program product of claim 18, wherein the copy of the electronic mail message is stored in an archive database, wherein the archive database is a storage repository separate from the electronic mail system.

20. The computer program product of claim 18, wherein the set of interrelated arguments and algorithms include at least one of rules linking organizational charts to projects, rules linking individuals to work responsibilities, rules linking keywords to subjects, rules tracking locality of reference for individual electronic mail messages in time or users, or algorithms scoring electronic mail messages against existing arguments.
